(19) United States
(12) Patent Application Publication
(10) Pub. No.: US 2021/0035279 A1
(43) Pub. Date: Feb. 4, 2021

(54) Perception System Diagnostic Systems And Methods

(71) Applicant: GM GLOBAL TECHNOLOGY OPERATIONS LLC, Detroit, MI (US)

(72) Inventors: Yao HU, Sterling Heights, MI (US); Wei TONG, Troy, MI (US); Wen-Chiao LIN, Rochester Hills, MI (US)

(21) Appl. No.: 16/527,561

(22) Filed: Jul. 31, 2019

(51) Int. Cl. G06T 7/00; H04N 17/00; G07C 5/08

(52) U.S. Cl. CPC G06T 7/0002; G06T 7/97; H04N 17/002; H04N 5/247; G07C 5/0866; G06T 2207/30252; G06T 2207/30168; G07C 5/0808

(57) ABSTRACT

A diagnostic system includes: a first feature extraction module configured to extract features present in an image captured by a camera of a vehicle; a second feature extraction module configured to extract features present in the image captured by the camera of the vehicle; a first feature matching module configured to match the image captured by the camera with first images stored in a database and to output one of the first images based on the matching; a second feature matching module configured to, based on a comparison of the one of the first images with the image captured by the camera, determine a score value that corresponds to closeness between the one of the first images and the image captured by the camera; and a fault module configured to selectively diagnose a fault based on the score value and output a fault indicator based on the diagnosis.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to perception systems of vehicles and more particularly to systems and methods for diagnosing faults in perception systems of vehicles.

Vehicles include one or more torque producing devices, such as an internal combustion engine and/or an electric motor. A passenger of a vehicle rides within a passenger cabin (or passenger compartment) of the vehicle.

Vehicles may include one or more different type of sensors that sense vehicle surroundings. One example of a sensor that senses vehicle surroundings is a camera configured to capture images of the vehicle surroundings. Examples of such cameras include forward facing cameras, rear facing cameras, and side facing cameras. Another example of a sensor that senses vehicle surroundings includes a radar sensor configured to capture information regarding vehicle surroundings. Other examples of sensors that sense vehicle surroundings include sonar sensors and light detection and ranging (LIDAR) sensors configured to capture information regarding vehicle surroundings.

### SUMMARY

In a feature, a diagnostic system includes: a first feature extraction module configured to extract features present in an image captured by a camera of a vehicle; a second feature extraction module configured to extract features present in the image captured by the camera of the vehicle; a first feature matching module configured to match the image captured by the camera with first images stored in a database and to output one of the first images based on the matching; a second feature matching module configured to, based on a comparison of the one of the first images with the image captured by the camera, determine a score value that corresponds to closeness between the one of the first images and the image captured by the camera; and a fault module configured to selectively diagnose a fault based on the score value and output a fault indicator based on the diagnosis.

In further features, the fault module is configured to: determine a severity value based on the score value; and selectively diagnose a fault when the severity value is greater than a first predetermined value.

In further features, the fault module is configured to diagnose that no fault is present when the severity value is less than a second predetermined value.

In further features, the second predetermined value is less than the first predetermined value.

In further features, the fault module is configured to diagnose a fault of a first level and set the fault indicator to a first state when the severity value is less than the first predetermined value and greater than the second predetermined value.

In further features, the fault module is configured to diagnose that a first fault is present when a value that is indicative of closeness between the one of the first images and the image captured by the camera is greater than a third predetermined value.

In further features: the database includes normal images and faulty images; and the first fault is indicative of the one of the first images being one of the faulty images.

In further features: the database includes normal images and faulty images; and the fault module is configured to diagnose that a second fault is present when: a first value that is indicative of a difference between the image captured by the camera and one of the normal images is less than a fourth predetermined value; and a second value that is indicative of a difference between a first location at which the camera captured the image and a second location where the one of the normal images was captured is greater than a fifth predetermined value.

In further features, the second fault includes a global positioning system (GPS) fault.

In further features: the database includes normal images and faulty images; and the fault module is configured to diagnose that a third fault is present when: a first value that is indicative of a difference between the image captured by the camera and one of the normal images is greater than a sixth predetermined value; a second value that is indicative of a difference between a first time when the camera captured the image and a second time when the one of the normal images was captured is greater than a seventh predetermined value; and a third value that is indicative of a difference between a first location at which the camera captured the image and a second location where the one of the normal images was captured is less than an eighth predetermined value.

In further features, the third fault is a possible fault associated with a perception system of the vehicle.

In further features, the fault module is configured to output an alert indicative of a request to inspect a perception system of the vehicle when the third fault is present.

In further features, the fault module is configured to update the database with the image captured by the camera when the third fault is present.

In further features: the database includes normal images and faulty images; and the fault module is configured to diagnose that a fourth fault is present when: a first value that is indicative of a difference between labels attributed to features of the image captured by the camera and labels attributed to one of the normal images is greater than a ninth predetermined value; a second value that is indicative of a difference between the image captured by the camera and the one of the normal images is less than a tenth predetermined value; and a third value that is indicative of a difference between a first location at which the camera captured the image and a second location where the one of the normal images was captured is less than an eleventh predetermined value.

In further features, the fourth fault is associated with code of a perception system of the vehicle.

In further features: the database includes normal images and faulty images; and the fault module is configured to diagnose that a fifth fault is present when at least one of: the first value that is indicative the difference between labels attributed to features of the image captured by the camera and labels attributed to one of the normal images is not greater than the ninth predetermined value; the second value that is indicative of the difference between the image captured by the camera and the one of the normal images is not less than the tenth predetermined value; and the third value that is indicative of the difference between the first location at which the camera captured the image and the second location where the one of the normal images was captured is not less than the eleventh predetermined value.

In further features, the fifth fault is associated with hardware of a perception system of the vehicle.

In further features, the fault module is configured to determine the severity value further based on a first value that is indicative of a difference between labels attributed to features of the image captured by the camera and labels attributed to one of the normal images.

In further features, the fault module is configured to determine the severity value further based on: a second value that is indicative of a difference between the image captured by the camera and the one of the normal images; and a third value that is indicative of a difference between a first location at which the camera captured the image and a second location where the one of the normal images was captured.

In a feature, a diagnostic method includes: extracting features present in an image captured by a camera of a vehicle; extracting features present in the image captured by the camera of the vehicle; matching the image captured by the camera with first images stored in a database; outputting one of the first images based on the matching; based on a comparison of the one of the first images with the image captured by the camera, determining a score value that corresponds to closeness between the one of the first images and the image captured by the camera; selectively diagnosing a fault based on the score value; and outputting a fault indicator based on the diagnosis.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system;

FIG. 2 is a functional block diagram of a vehicle including various external cameras and sensors;

FIG. 3 is a functional block diagram of an example implementation of a perception module and a diagnostic module;

FIG. 4 is a functional block diagram of a second feature matching module;

FIG. 5 is a flowchart depicting an example method performed by a fault module;

FIG. 6 includes a functional block diagram of an example training system for training of a diagnostic module;

FIG. 7 is an example raw image divided into quadrants, where each of the quadrants is also divided into quadrants, and illustrating gradient orientations and gradient magnitudes;

FIG. 8 includes an example keypoint descriptor generated based on the example of FIG. 7;

FIG. 9 includes an example raw image with features shown boxed;

FIG. 10 includes example graph of frequencies of code words generated for the example raw image of FIG. 9;

FIG. 11 includes an example representation of features of sample images in a sample database; and

FIG. 12 includes an example representation of code words as clusters of features of the sample images of the sample database.

In the drawings, reference numbers may be reused to identify similar and/or identical elements.

### DETAILED DESCRIPTION

A vehicle may include a perception system that perceives objects located around the vehicle based on data from external cameras and sensors. Examples of external cameras include forward facing cameras, rear facing cameras, and side facing cameras. External sensors include radar sensors, light detection and ranging (LIDAR) sensors, and other types of sensors.

According to the present disclosure, a diagnostic module selectively diagnoses faults associate with the perception system of a vehicle based on comparisons of data from an external camera or sensor of a vehicle with data stored in a sample database. The data stored in the sample database may be previously captured by the vehicle and/or by other vehicles.

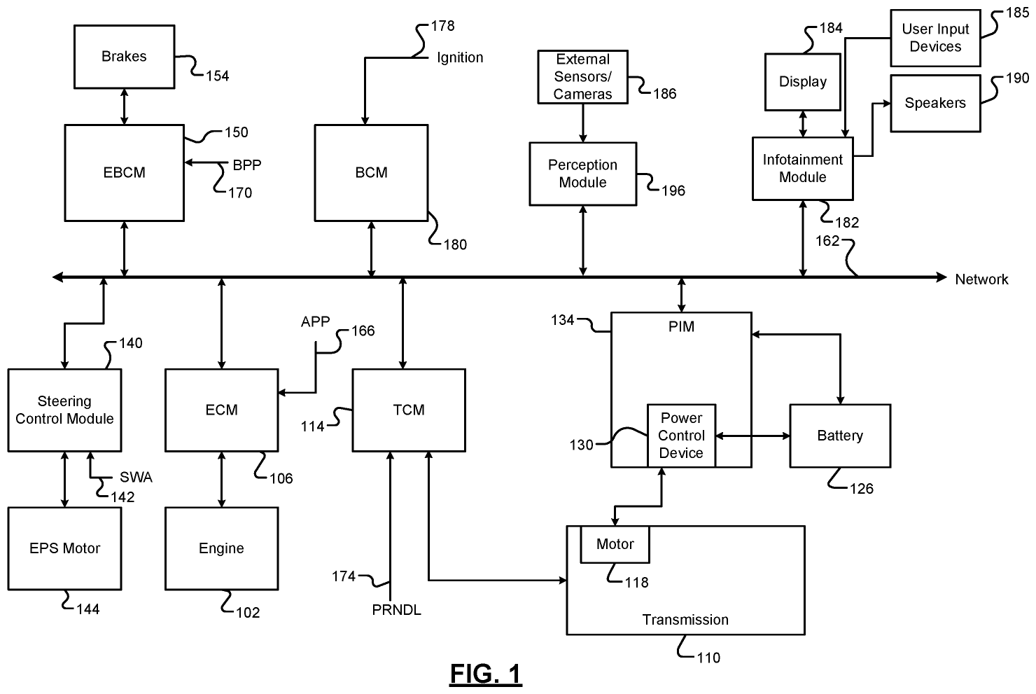

Referring now to FIG. 1, a functional block diagram of an example vehicle system is presented. While a vehicle system for a hybrid vehicle is shown and will be described, the present disclosure is also applicable to non-hybrid vehicles, electric vehicles, fuel cell vehicles, autonomous vehicles, and other types of vehicles. Also, while the example of a vehicle is provided, the present application is also applicable to non-vehicle implementations.

An engine 102 may combust an air/fuel mixture to generate drive torque. An engine control module (ECM) 106 controls the engine 102. For example, the ECM 106 may control actuation of engine actuators, such as a throttle valve, one or more spark plugs, one or more fuel injectors, valve actuators, camshaft phasers, an exhaust gas recirculation (EGR) valve, one or more boost devices, and other suitable engine actuators. In some types of vehicles (e.g., electric vehicles), the engine 102 may be omitted.

The engine 102 may output torque to a transmission 110. A transmission control module (TCM) 114 controls operation of the transmission 110. For example, the TCM 114 may control gear selection within the transmission 110 and one or more torque transfer devices (e.g., a torque converter, one or more clutches, etc.).

The vehicle system may include one or more electric motors. For example, an electric motor 118 may be implemented within the transmission 110 as shown in the example of FIG. 1. An electric motor can act as either a generator or as a motor at a given time. When acting as a generator, an electric motor converts mechanical energy into electrical energy. The electrical energy can be, for example, used to charge a battery 126 via a power control device (PCD) 130. When acting as a motor, an electric motor generates torque that may be used, for example, to supplement or replace torque output by the engine 102. While the example of one electric motor is provided, the vehicle may include zero or more than one electric motor.

A power inverter control module (PIM) 134 may control the electric motor 118 and the PCD 130. The PCD 130 applies power from the battery 126 to the electric motor 118 based on signals from the PIM 134, and the PCD 130 provides power output by the electric motor 118, for example, to the battery 126. The PIM 134 may be referred to as a power inverter module (PIM) in various implementations.

A steering control module 140 controls steering/turning of wheels of the vehicle, for example, based on driver turning of a steering wheel within the vehicle and/or steering commands from one or more vehicle control modules. A steering wheel angle sensor (SWA) monitors rotational position of the steering wheel and generates a SWA 142 based on the position of the steering wheel. As an example, the steering control module 140 may control vehicle steering via an EPS motor 144 based on the SWA 142. However, the vehicle may include another type of steering system.

An electronic brake control module (EBCM) 150 may selectively control brakes 154 of the vehicle. Modules of the vehicle may share parameters via a controller area network (CAN) 162. The CAN 162 may also be referred to as a car area network. For example, the CAN 162 may include one or more data buses. Various parameters may be made available by a given control module to other control modules via the CAN 162.

The driver inputs may include, for example, an accelerator pedal position (APP) 166 which may be provided to the ECM 106. A brake pedal position (BPP) 170 may be provided to the EBCM 150. A position 174 of a park, reverse, neutral, drive lever (PRNDL) may be provided to the TCM 114. An ignition state 178 may be provided to a body control module (BCM) 180. For example, the ignition state 178 may be input by a driver via an ignition key, button, or switch. At a given time, the ignition state 178 may be one of off, accessory, run, or crank.

The vehicle system may also include an infotainment module 182. The infotainment module 182 controls what is displayed on a display 184. The display 184 may be a touchscreen display in various implementations and transmit signals indicative of user input to the display 184 to the infotainment module 182. The infotainment module 182 may additionally or alternatively receive signals indicative of user input from one or more other user input devices 185, such as one or more switches, buttons, knobs, etc. The infotainment module 182 may also generate output via one or more other devices. For example, the infotainment module 182 may output sound via one or more speakers 190 of the vehicle.

The vehicle may include a plurality of external sensors and cameras, generally illustrated in FIG. 1 by 186. One or more actions may be taken based on input from the external sensors and cameras 186. For example, the infotainment module 182 may display video, various views, and/or alerts on the display 184 via input from the external sensors and cameras 186.

As another example, based on input from the external sensors and cameras 186, a perception module 196 perceives objects around the vehicle and locations of the objects relative to the vehicle. The ECM 106 may adjust torque output of the engine 102 based on input from the perception module 196. Additionally or alternatively, the PIM 134 may control power flow to and/or from the electric motor 118 based on input from the perception module 196. Additionally or alternatively, the EBCM 150 may adjust braking based on input from the perception module 196. Additionally or alternatively, the steering control module 140 may adjust steering based on input from the perception module 196.

The vehicle may include one or more additional control modules that are not shown, such as a chassis control module, a battery pack control module, etc. The vehicle may omit one or more of the control modules shown and discussed.

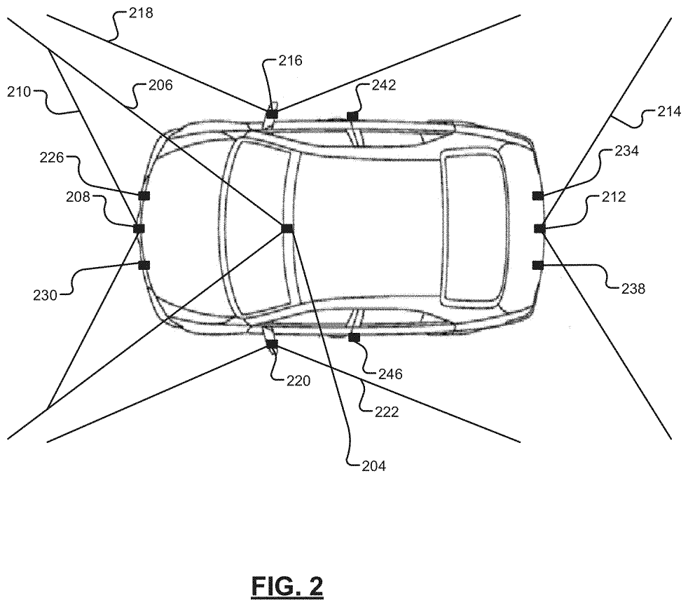

Referring now to FIG. 2, a functional block diagram of a vehicle including examples of external sensors and cameras is presented. The external sensors and cameras 186 include various cameras positioned to capture images and video outside of (external to) the vehicle and various types of sensors measuring parameters outside of (external to the vehicle). For example, a forward facing camera 204 captures images and video of images within a predetermined field of view (FOV) 206 in front of the vehicle.

A front camera 208 may also capture images and video within a predetermined FOV 210 in front of the vehicle. The front camera 208 may capture images and video within a predetermined distance of the front of the vehicle and may be located at the front of the vehicle (e.g., in a front fascia, grille, or bumper). The forward facing camera 204 may be located more rearward, however, such as with a rear view mirror at a windshield of the vehicle. The forward facing camera 204 may not be able to capture images and video of items within all of or at least a portion of the predetermined FOV of the front camera 208 and may capture images and video that is greater than the predetermined distance of the front of the vehicle. In various implementations, only one of the forward facing camera 204 and the front camera 208 may be included.

A rear camera 212 captures images and video within a predetermined FOV 214 behind the vehicle. The rear camera 212 may capture images and video within a predetermined distance behind vehicle and may be located at the rear of the vehicle, such as near a rear license plate.

A right camera 216 captures images and video within a predetermined FOV 218 to the right of the vehicle. The right camera 216 may capture images and video within a predetermined distance to the right of the vehicle and may be located, for example, under a right side rear view mirror. In various implementations, the right side rear view mirror may be omitted, and the right camera 216 may be located near where the right side rear view mirror would normally be located.

A left camera 220 captures images and video within a predetermined FOV 222 to the left of the vehicle. The left camera 220 may capture images and video within a predetermined distance to the left of the vehicle and may be located, for example, under a left side rear view mirror. In various implementations, the left side rear view mirror may be omitted, and the left camera 220 may be located near where the left side rear view mirror would normally be located. While the example FOVs are shown for illustrative purposes, the FOVs may overlap, for example, for more accurate and/or inclusive stitching.

The external sensors and cameras 186 may additionally or alternatively include various other types of sensors, such as ultrasonic (e.g., radar) sensors. For example, the vehicle may include one or more forward facing ultrasonic sensors, such as forward facing ultrasonic sensors 226 and 230, one or more rearward facing ultrasonic sensors, such as rearward facing ultrasonic sensors 234 and 238. The vehicle may also include one or more right side ultrasonic sensors, such as right side ultrasonic sensor 242, and one or more left side ultrasonic sensors, such as left side ultrasonic sensor 246. The locations of the cameras and ultrasonic sensors are provided as examples only and different locations could be used. Ultrasonic sensors output ultrasonic signals around the vehicle.

The external sensors and cameras 186 may additionally or alternatively include one or more other types of sensors, such as one or more sonar sensors, one or more radar sensors, and/or one or more light detection and ranging (LIDAR) sensors.

FIG. 3 is a functional block diagram of an example implementation of the perception module 196 and a diagnostic module 300. The diagnostic module 300 selectively diagnoses faults associated with the perception module 196 and the external sensors and cameras 186.

A snapshot module 304 captures a snapshot 308 of data including data from one of the external sensors and cameras 186. The snapshot module 304 may capture a new snapshot each predetermined period. The snapshot 308 may include a forward facing image 312 captured using the forward facing camera 204, a time 316 (and date) that the forward facing image 312 was captured, and a location 320 of the vehicle at the time that the forward facing image 312 was captured. While the example of the snapshot including the forward facing image 312 will be discussed, the present application is also applicable to data from other ones of the external sensors and cameras 186. A clock may track and provide the (present) time 316. A global position system (GPS) may track and provide the (present) location 320. Snapshots may be obtained and the following may be performed for each one of the external sensors and cameras 186.

A feature extraction module 324 identifies features and locations 328 of the features in the forward facing image 312 of the snapshot 308. Examples of features include, for example, edges of objects, shapes of objects, etc. The feature extraction module 324 may identify the features and locations using one or more feature extraction algorithms, such as a scale invariant feature transform (SIFT) algorithm, a speeded up robust features (SURF) algorithm, and/or one or more other feature extraction algorithms.

The SIFT algorithm can be described as follows. A raw image (e.g., the forward facing image 312) can be referenced as I(x,y). A scale space can be defined as

$$L ( x , y , σ ) = G ( x , y , σ ) * I ( x , y ) . \\ G ( x , y , σ ) = \frac{1}{2 π {σ}^{2}} exp ( - \frac{{x}^{2} + {y}^{2}}{2 {σ}^{2}} ) . \\ Also , \\ D ( x , y , σ ) = L ( x , y , k σ ) - L ( x , y , σ ) .$$

For local extrema D(x,y,σ), each sample point is compared to its eight neighbors in the raw image and its 9 neighbors in the scale space above and below. Keypoints can be defined as

$$x = {( x , y , σ )}^{T} and \hat{x} = - \frac{{\partial }^{2} {D}^{- 1}}{\partial {x}^{2}} \frac{\partial D}{\partial x} .$$

Points with low contrast and edges are filtered out.

Gradient orientation of the raw image can be described as

θ(x, y)=tan⁻¹((L(x, y+1))−L(x, y−1))/(L(x+1, y))−L(x−1, y))), and

gradient magnitude the raw image can be described as

$$m ( x , y ) = \sqrt{{( L ( x + 1 , y ) - L ( x - 1 , y ) )}^{2} + {( L ( x , y + 1 ) - L ( x , y - 1 ) )}^{2}} .$$

FIG. 7 illustrates an example raw image divided into quadrants, where each of the quadrants is also divided into quadrants. In FIG. 7, the gradient orientations are illustrated by arrows, and the gradient magnitudes are illustrated by the lengths of the arrows. FIG. 8 includes an example keypoint descriptor generated based on the example of FIG. 7.

An object module 332 labels objects in the forward facing image 312 of the snapshot 308 based on the features identified in the forward facing image 312 of the snapshot 308. For example, the object module 332 may identify shapes in the forward facing image 312 based on the shapes of the identified features and match the shapes with predetermined shapes of objects stored in a database. The object module 332 may attribute the names or code words of the predetermined shapes matched with shapes to the shapes of the identified features. The object module 332 outputs labeled objects and locations 336. As another example, a deep neural network module may implement the functionality of both the feature extraction module 324 and the object module 332. The first a few layers in such a deep neural network module perform the function of feature extraction, and then pass the features to the rest of the layers in the deep neural network module to perform the function of object labeling. A vehicle may have more than one feature extraction module independent from each other.

One or more actions may be taken based on the labeled objects and locations 336. For example, the infotainment module 182 may display video, various views, and/or alerts on the display 184. As another example, the ECM 106 may adjust torque output of the engine 102 based on the labeled objects and locations 336. Additionally or alternatively, the PIM 134 may control power flow to and/or from the electric motor 118 based on the labeled objects and locations 336. Additionally or alternatively, the EBCM 150 may adjust braking based on the labeled objects and locations 336. Additionally or alternatively, the steering control module 140 may adjust steering based on the labeled objects and locations 336.

The diagnostic module 300 also includes a feature extraction module 340. All or a part of the diagnostic module 300 may be implemented within the vehicle. Alternatively, all or a part of the diagnostic module 300 may be located remotely, such as at a remote server. If all or a part of the diagnostic module 300 is located remotely, the vehicle includes one or more transceivers that transmit data to and from the vehicle wirelessly, such as via a cellular transceiver, a WiFi transceiver, a satellite transceiver, and/or another suitable type of wireless communication.

The feature extraction module 340 also receives the snapshot 308. The feature extraction module 340 also identifies features and locations 344 of the features in the forward facing image 312 of the snapshot 308. The feature extraction module 340 may identify the features and locations using one or more feature extraction algorithms, such as a SIFT algorithm, a SURF algorithm, and/or one or more other feature extraction algorithms. The feature extraction module 340 may identify the features and locations using the same one or more feature extraction algorithms as the feature extraction module 324.

A first feature matching module 348 labels objects in the forward facing image 312 of the snapshot 308 based on the features identified in the forward facing image 312 of the snapshot 308. For example, the first feature matching module 348 may identify shapes in the forward facing image 312 based on the shapes of the identified features and match the shapes with predetermined shapes of objects stored in a database. The first feature matching module 348 may attribute the names or code words. Code words may be codes (e.g., numerical) of feature types) of the predetermined shapes matched with shapes to the shapes of the identified features.

Based on the labels given to the objects in the forward facing image 312 of the snapshot 308 and an inverted index 352 including data regarding sample images 354 stored in a sample database 356, the first feature matching module 348 identifies first images 360 that most closely match the forward facing image 312 of the snapshot 308. For example, the inverted index 352 may include an index including sets of names or code words attributed to the features in the sample images 354, respectively. The sets of names or code words attributed to the features of the sample images 354 may be stored in the sample database 356, for example, using a term frequency—inverse document frequency (TF-IDF) algorithm or another suitable type of algorithm. The TF-IDF may include weighting and/or hashing in various implementations. The sample database 356 may include forward facing images previously captured using the forward facing camera 204, forward facing images captured by one or more other vehicles, and other types of forward facing images. The sample database 356 may also include intentionally faulty images stored for fault diagnostics.

Regarding TF-IDF, f_{t,d} can be described as a raw count of a code word t in an image d. Term frequency tf(t,d) can be described as the frequency that a code word t occurs in an image d. As an example, tf(t,d)=log(1+f_{t,d}). Inverse document frequency idf(t,dD) measures if a code word t is common or rare across all images D={d}. As an example, idf(t,D)=log(N/nₜ) where N=|D| and nₜ=|{d ϵ D:t ϵ d}|. { } represents a set. |{ }| represents the number of elements in the set. TF-IDF can be described as tfidf(t,d,D)=tf(t,d)·idf(t,d).

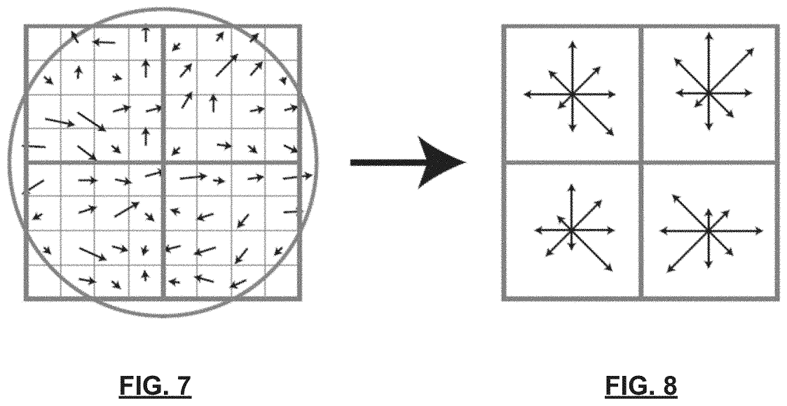

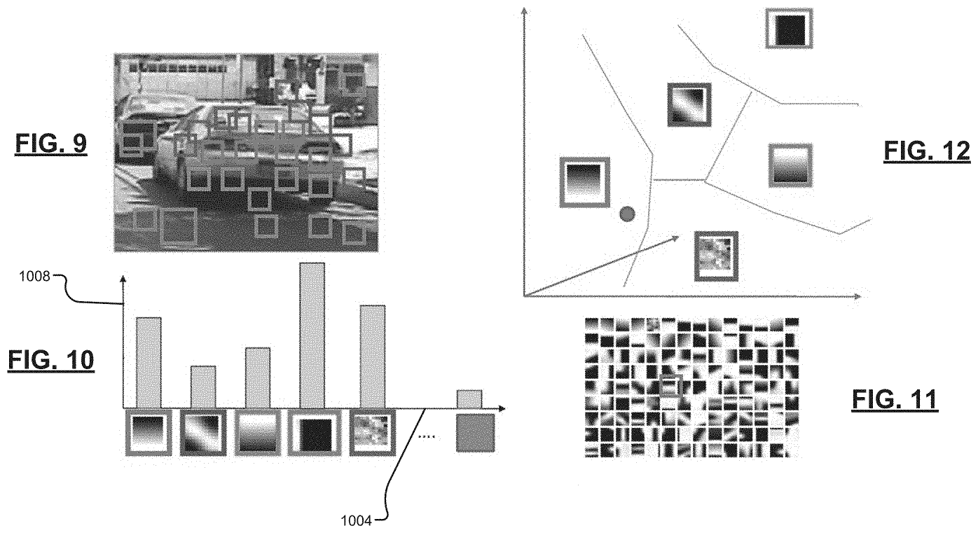

FIG. 9 includes an example raw image. FIG. 10 includes example graph of code words 1004 and their appearance frequency 1008 generated for the example raw image of FIG. 9. FIG. 11 includes an example representation of the features of the sample images 354 in the sample database 356. FIG. 12 includes an example representation of clusters of code words of the sample images of the sample database 356. Axes of the feature space are also shown. Features are grouped into clusters in the feature space.

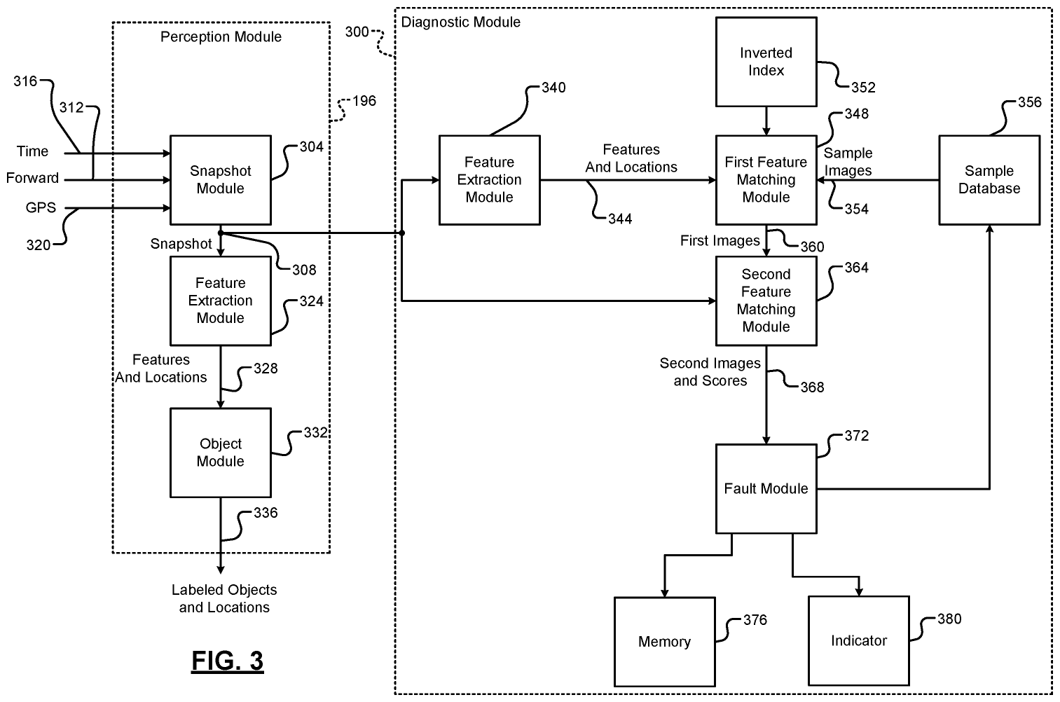

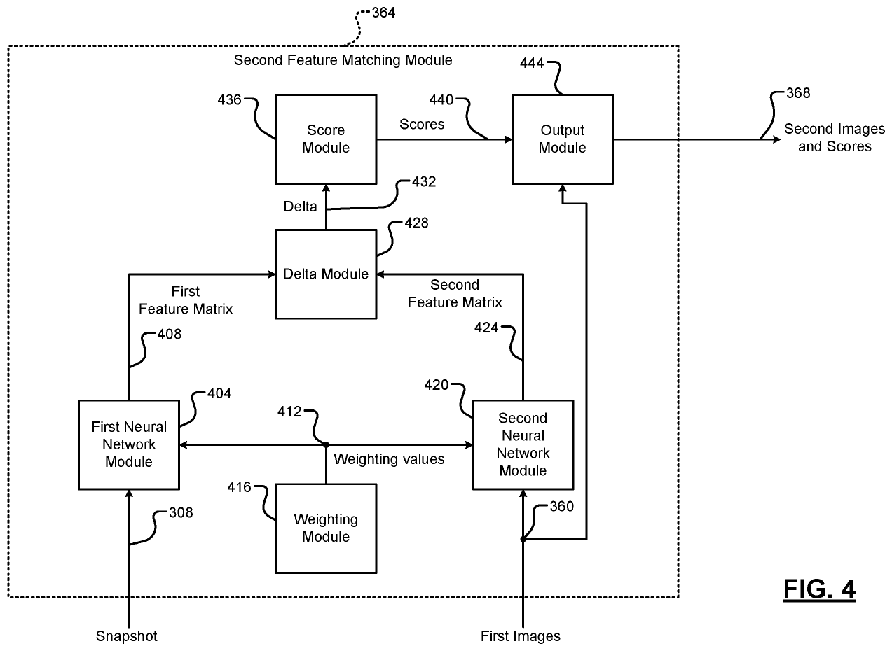

A second feature matching module 364 (see also FIG. 4) determines scores for the first images 360, respectively, by comparing the first images 360 with the forward facing image 312 of the snapshot 308. The score of one of the first images 360 may increase as closeness between the one of the first images 360 and the forward facing image 312 increases and vice versa. The second feature matching module 364 selects the one of the first images 360 having a highest score or all of the first images 360 with a score that is greater than a predetermined value (e.g., 0.9). The second feature matching module 364 outputs the selected one(s) of the first images 360 and the score(s), respectively, as second image(s) and score(s) 368.

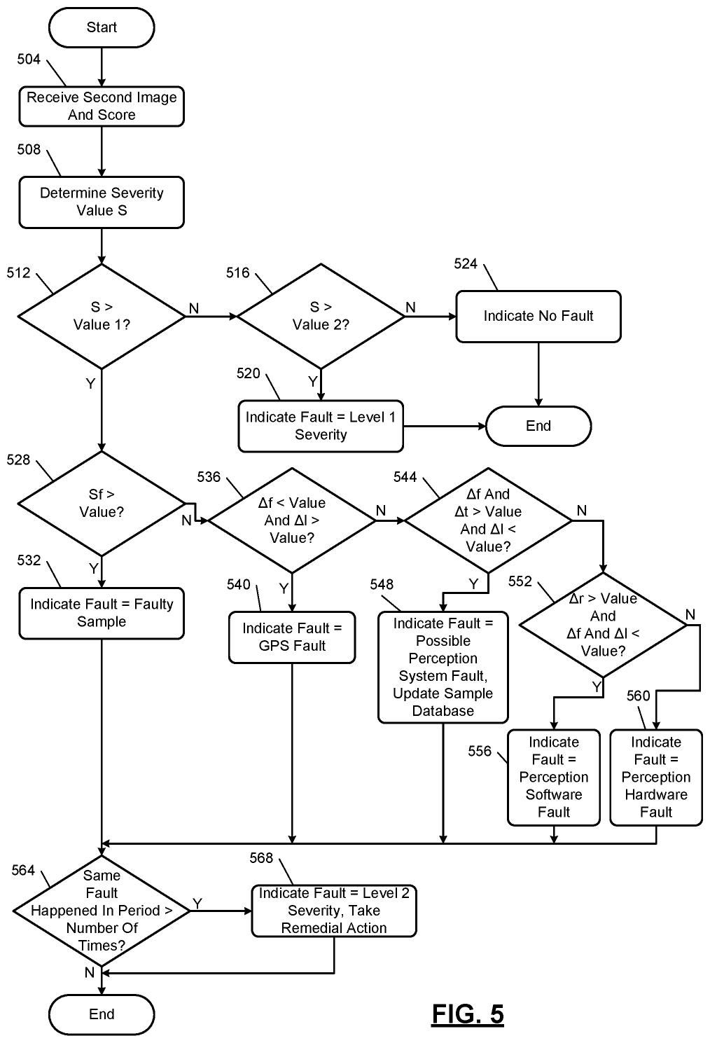

A fault module 372 (see also FIG. 5) selectively diagnoses faults associated with the perception system of the vehicle based on the output of the second feature matching module 364. The fault module 372 selectively takes one or more actions when a fault is diagnosed. For example, the fault module 372 may update or add one or more images in the sample database 356, store a predetermined fault indicator indicative of the fault in memory 376, output a fault alert, or take one or more other actions. Outputting the fault alert may include, for example, illuminating a fault indicator 380 of the vehicle and/or displaying a fault message on the display 184. The fault alert may prompt a user to seek vehicle service to remedy the fault.

FIG. 4 is a functional block diagram of an example implementation of the second feature matching module 364. A first neural network module 404 includes a first neural network, such as a first convolutional neural network (CNN) or another suitable type of neural network. The first neural network module 404 generates a first feature matrix 408 based on the forward facing image 312 of the snapshot 308 using the first neural network and weighting values 412 provided by a weighting module 416. The first neural network module 404 may, for example, extract features from the forward facing image 312 using the first neural network and perform post-processing (e.g., pooling, normalization, and/or one or more other post-processing functions) on the output of the first neural network to produce the first feature matrix 408. The first feature matrix 408 includes a matrix of values representative of features present in the forward facing image 312.

A second neural network module 420 includes a second neural network, such as a second CNN or another suitable type of neural network. The second neural network is the same type of neural network as the first neural network. The second neural network module 420 generates a second feature matrix 424 based on one of the first images 360 using the second neural network and the weighting values 412 provided by the weighting module 416. The second neural network module 420 may, for example, extract features from the one of the first images 360 using the second neural network and perform post-processing (e.g., pooling, normalization, and/or one or more other post-processing functions) on the output of the second neural network to produce the second feature matrix 424. The second feature matrix 424 includes a matrix of values representative of features present in the one of the first images 360. The second neural network module 420 generates a second feature matrix for each of the first images 360.

A delta module 428 determines a delta value 432 based on a difference between the first feature matrix 408 and the second feature matrix 424 for the one of the first images 360. The delta module 428 determines a delta value 432 for each different second feature matrix based on the difference between the first feature matrix 408 and that second feature matrix. For example, the delta module 428 may set the delta value 432 using the equation:

Δ=∥f̅(1)−f̅(2)∥,

where Δ is the delta value 432, f̅(1) is the first feature matrix 408, and f̅(2) is the second feature matrix 424 for the one of the first images 360. The delta module 428 determines a delta value for each second feature matrix based on the first feature matrix 408 and that one of the second feature matrices.

A score module 436 determines a score value 440 for each one of the first images 360 based on the delta value 432 determined that one of the first images 360. For example, the score module 436 may determine the score value 440 for one of the first images 360 based on the delta value 432 determined for that one of the first images 360 and the exponent function. For example only, the score module 436 may determine the score value 440 for one of the first images 360 using the equation:

s=exp(−Δ),

where s is the score value 440 for the one of the first images 360 and Δ is the delta value 432 determined for the one of the first images 360 based on the second feature matrix 424 for the one of the first image 360 and the first feature matrix 408. The score module 436 determines a score value for each delta value (for the respective one of the first images 360). The score value therefore reflects the relative closeness between the forward facing image 312 and that one of the first images 360. In the example of the equation above, the score value increases (e.g., approaches 1) as the closeness between the forward facing image 312 and that one of the first images 360 increases. The score value decreases (e.g., approaches zero) as closeness between the forward facing image 312 and that one of the first images 360 decreases.

An output module 444 selects one or more of the first images 360 based on the score values 440, respectively. For example, the output module 444 may select all of the first images 360 having score values 440 that are greater than a predetermined value (e.g., 0.9) or a predetermined number (e.g., 1 or more) of the first images 360 having the highest scores. The output module 444 outputs the selected one or more of the first images 360 and the respective score values 440 to the fault module 372 as the second images and scores 368.

FIG. 5 includes a flowchart depicting an example method performed by the fault module 372. Control begins with 504 where the fault module 372 receives the second image(s) and the respective score(s). In the example where two or more second images and respective scores are provided, FIG. 5 may be performed for each of the second images once control reaches an end.

At 508, the fault module 372 determines a severity value (S) for one of the second images. The fault module 372 may determine the severity value based on similarity of the forward facing image 312 with the one of the second images which is a faulty image stored in the sample database 356, differences between the time of the forward facing image 312 and the time of the one of the second images which is a normal (non-faulty) image stored in the sample database 356, differences between the location of the forward facing image 312 and the location of the one of the second images which is a normal image stored in the sample database 356, differences between labels of the forward facing image 312 and labels of the one of the second images which is a normal image stored in the sample database 356, and differences between features of the forward facing image 312 and features of the one of the second images which is a normal image stored in the sample database 356. The fault module 372 may determine the severity value using one of a lookup table and an equation that relates the differences and similarities to severity values. For example, the fault module 372 may determine the severity value using the equation:

S=w₁Δ_{f}+w₂Δₗ+w₃s_{f}+w₁Δᵣ,

where S is the severity value for the one of the second images, w1-w4 are weighting values, Δ_{f} is a difference between features of the forward facing image 312 and features of the one of the second images which is a normal image stored in the sample database 356, Δₗ is a difference between the location of the forward facing image 312 and the location of the one of the second images which is a normal image stored in the sample database 356, s_{f} is a value that reflects a similarity between the forward facing image 312 and the one of the second images which is a faulty image stored in the sample database 356, and Δᵣ is a difference between labels of the forward facing image 312 and labels of the one of the second images which is a normal image stored in the sample database 356. The weighting values may be predetermined values.

The fault module 372 may set Δ_{f} as follows

Δ_{f}=mean(Δ_{i,j}),

where Δ_{i,j} is difference between features of the forward facing image 312 (i-th image) and features of the j-th normal image of the sample database. The fault module 372 may set Δₗ as follows

$${Δ}_{l} = mean ( \sqrt{{∝}_{1} {( l o {n}_{i} - {lon}_{j} )}^{2} + {∝}_{1} {( {lat}_{i} - {lat}_{j} )}^{2} + {∝}_{1} {( {alt}_{i} - {alt}_{j} )}^{2}} ) ,$$

where lonᵢ is the longitude of the i-th image, lonⱼ is the longitude of the j-th image, latᵢ is the latitude of the i-th image, latⱼ is the latitude of the j-th image, atlᵢ is the altitude of the i-th image, and altⱼ is the altitude of the j-th image. The fault module 372 may set Δₜ as follows

Δₜ=mean(|tᵢ−tⱼ|),

where tᵢ is the time of the i-th image and tⱼ is the time of the j-th image. The fault module 372 may set sf as follows

s_{f}=mean(s_{i,k}),

where s_{i,k} is the score value determined based on the i-th image and a k-th faulty image stored in the sample database 356.

At 512, the fault module 372 determines whether the severity value (S) is greater than a first predetermined value (Value 1). If 512 is true, control continues with 528, which is discussed further below. If 512 is false, control transfers to 516. At 516, the fault module 372 determines whether the severity value (S) is greater than a second predetermined value (Value 2). If 516 is true, the fault module 372 indicates that a fault with a first level of severity has occurred at 520, and control may end. For example, the fault module 372 may set the fault indicator in memory to a first state at 516. If 516 is false, the fault module 372 may indicate that no fault is present at 524, and control may end. The second predetermined value is less than the first predetermined value.

At 528, the fault module 372 determines whether the value sf is greater than a third predetermined value. If 528 is true, the fault module 372 indicates that a faulty sample from the sample database 356 has been matched at 532 (fault=faulty sample) and control continues with 564, which is discussed further below. If 528 is false, control transfers to 536.

At 536, the fault module 372 determines whether Δ_{f} is less than a fourth predetermined value and Δₗ is greater than a fifth predetermined value. If 536 is true, the fault module 372 indicates that a sample from a different location has been matched at 540 (fault=GPS fault) and that a fault associated with the GPS system is present, and control continues with 564, which is discussed further below. If 536 is false, control transfers to 544.

At 544, the fault module 372 determines whether Δ_{f} is greater than a sixth predetermined value, Δₜ is greater than a seventh predetermined value, and Δₗ is less than an eighth predetermined value. If 544 is true, the fault module 372 indicates that a possible perception system fault may be present at 548 (fault=possible perception system fault), and control continues with 564. The fault module may update the sample database 356 (e.g., store the snapshot 308 in the sample database 356) and/or output an indicator to inspect the perception system of the vehicle at 548. If 544 is false, control transfers to 552.

At 552, the fault module 372 determines whether Δᵣ is greater than a ninth predetermined value, Δ_{f} is less than a tenth predetermined value, and Δₗ is less than an eleventh predetermined value. If 552 is true, the fault module 372 indicates the presence of a fault in the code (e.g., software) associated with the perception system (fault=perception system code fault) at 556, and control continues with 564. If 552 is false, the fault module 372 indicates that the presence of a fault in the hardware associated with the perception system (fault=perception system hardware fault) at 560, and control continues with 564. The fault module 372 may set Δᵣ as follows

$${Δ}_{r} = mean ( \sqrt{( {{β}_{1} ( {h}_{i , 1} - {h}_{j , 1} )}^{2} + {{β}_{2} ( {h}_{i , 2} - {h}_{j , 2} )}^{2} + … + {{β}_{c} ( {h}_{i , c} - {h}_{j , c} )}^{2}} ) ,$$

where h_{i,p} is the count of each type of object detected in the i-th image, p is equal to 1, 2, . . . C, h_{j,p} is the count of each type of object detected in the j-th image, and βₚ are predetermined values set, for example, based on a static object.

h_{i,p}=|{c_{i,n}|c_{i,n}=p}|,

hᵢ=[h_{i,1}, h_{i,2}, . . . , h_{i,c}], and

rᵢ={c_{i,n}},

were rᵢ corresponds to the perception labels in the i-th image, and c_{i,n} is the object type detected in i-th image.

At 564, the fault module 564 determines whether the same type of fault (e.g., perception system hardware fault, perception system code fault, GPS fault, perception system fault, faulty sample fault) has happened more than a predetermined number of times within the last predetermined period. The predetermined number of times may be, for example, 5, 10, or another suitable number. The predetermined period may be, for example, the last 100 snapshots, the last 500 snapshots, or another suitable number of snapshots. Alternatively, the predetermined period may be a period, such as 1 minute, 5 minutes, 10 minutes, or another suitable period. If 564 is true, the fault module 372 indicates that a fault with a second level of severity has occurred at 568, and control may end. For example, the fault module 372 may set the fault indicator in memory to a second state at 568. The fault module 372 may also take one or more other remedial actions at 568, such as illuminating the fault indicator 380 of the vehicle and/or displaying the fault message on the display 184. If 564 is false, control may end.

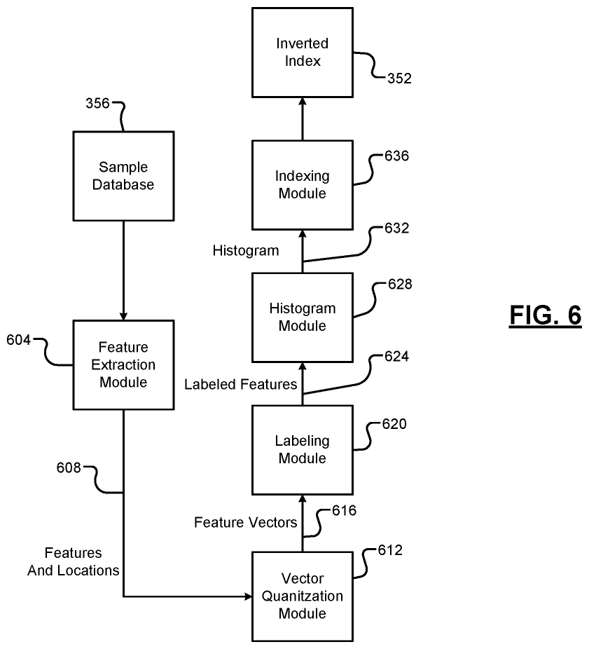

FIG. 6 includes a functional block diagram of an example training system for training of the diagnostic module 300. A feature extraction module 604 selects one of the images in the sample database 356 and identifies features and locations 608 of the features in the selected image. While the example of one of the images will be discussed, the following will be performed for each of the images of the sample database 356 over time. Examples of features include, for example, edges of objects, shapes of objects, etc.

The feature extraction module 604 may identify the features and locations using one or more feature extraction algorithms, such as a scale invariant feature transform (SIFT) algorithm, a speeded up robust features (SURF) algorithm, and/or one or more other feature extraction algorithms. The feature extraction module 604 may identify features and location using the same one or more feature extraction algorithms as the feature extraction modules 324 and 340.

A vector quantization module 612 generates vectors 616 for the features, respectively. The vectors 616 may reflect, for example, the gradient magnitudes and orientations discussed above.

A labeling module 620 labels objects in the selected image based on the features identified in the selected image. For example, the labeling module 620 may identify shapes in the selected based on the shapes of the identified features and match the shapes with predetermined shapes of objects stored in a database. The labeling module 620 may attribute the names or code words of the predetermined shapes matched with shapes to the shapes of the identified features. The labeling module 620 outputs labeled objects/features 624.

A histogram module 628 generates a histogram 632 for the selected image based on the labeled features 624 of the selected image. An example histogram is shown in FIG. 10. The histogram 632 includes a frequency of each different type of feature in the selected image. For example, the histogram 632 may include a count of a number of instances of each different type of feature in the selected image.

An indexing module 636 performs indexing (e.g., TF-IDF) based on the histogram 632 and updates the inverted index 352 based on the indexing such that the inverted index 352 includes information regarding the selected image of the sample database 356. The inverted index 352 is used by the first feature matching module 348 to identify the first images that most closely match the forward facing images of snapshots.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A diagnostic system comprising:
a first feature extraction module configured to extract features present in an image captured by a camera of a vehicle;
a second feature extraction module configured to extract features present in the image captured by the camera of the vehicle;
a first feature matching module configured to match the image captured by the camera with first images stored in a database and to identify one of the first images based on the matching;
a second feature matching module configured to, based on a comparison of the identified one of the first images with the image captured by the camera, determine a score value that corresponds to closeness between the identified one of the first images and the image captured by the camera; and
a fault module configured to:
determine a severity value based on the score value;
selectively diagnose a fault when the severity value is greater than a first predetermined value; and
output a fault indicator based on the diagnosis.

2. (canceled)

3. The diagnostic system of claim 1 wherein the fault module is configured to diagnose that no fault is present when the severity value is less than a second predetermined value.

4. The diagnostic system of claim 3 wherein the second predetermined value is less than the first predetermined value.

5. The diagnostic system of claim 3 wherein the fault module is configured to diagnose a fault of a first level and set the fault indicator to a first state when the severity value is less than the first predetermined value and greater than the second predetermined value.

6. The diagnostic system of claim 1 wherein the fault module is configured to diagnose that a first fault is present when a value that is indicative of closeness between the identified one of the first images and the image captured by the camera is greater than a third predetermined value.

7. The diagnostic system of claim 6 wherein:
the database includes normal images and faulty images; and
the first fault is indicative of the one of the first images being one of the faulty images.

8. The diagnostic system of claim 1 wherein:
the database includes normal images and faulty images; and
the fault module is configured to diagnose that a second fault is present when:
a first value that is indicative of a difference between the image captured by the camera and one of the normal images is less than a fourth predetermined value; and
a second value that is indicative of a difference between a first location at which the camera captured the image and a second location where the one of the normal images was captured is greater than a fifth predetermined value.

9. The diagnostic system of claim 8 wherein the second fault includes a global positioning system (GPS) fault.

10. The diagnostic system of claim 1 wherein:
the database includes normal images and faulty images; and
the fault module is configured to diagnose that a third fault is present when:
a first value that is indicative of a difference between the image captured by the camera and one of the normal images is greater than a sixth predetermined value;
a second value that is indicative of a difference between a first time when the camera captured the image and a second time when the one of the normal images was captured is greater than a seventh predetermined value; and
a third value that is indicative of a difference between a first location at which the camera captured the image and a second location where the one of the normal images was captured is less than an eighth predetermined value.

11. The diagnostic system of claim 10 wherein the third fault is a possible fault associated with a perception system of the vehicle.

12. The diagnostic system of claim 10 wherein the fault module is configured to output an alert indicative of a request to inspect a perception system of the vehicle when the third fault is present.

13. The diagnostic system of claim 10 wherein the fault module is configured to update the database with the image captured by the camera when the third fault is present.

14. The diagnostic system of claim 1 wherein:
the database includes normal images and faulty images; and
the fault module is configured to diagnose that a fourth fault is present when:
a first value that is indicative of a difference between labels attributed to features of the image captured by the camera and labels attributed to one of the normal images is greater than a ninth predetermined value;
a second value that is indicative of a difference between the image captured by the camera and the one of the normal images is less than a tenth predetermined value; and
a third value that is indicative of a difference between a first location at which the camera captured the image and a second location where the one of the normal images was captured is less than an eleventh predetermined value.

15. The diagnostic system of claim 14 wherein the fourth fault is associated with code of a perception system of the vehicle.

16. The diagnostic system of claim 14 wherein:
the database includes normal images and faulty images; and
the fault module is configured to diagnose that a fifth fault is present when at least one of:
the first value that is indicative the difference between labels attributed to features of the image captured by the camera and labels attributed to one of the normal images is not greater than the ninth predetermined value;
the second value that is indicative of the difference between the image captured by the camera and the one of the normal images is not less than the tenth predetermined value; and
the third value that is indicative of the difference between the first location at which the camera captured the image and the second location where the one of the normal images was captured is not less than the eleventh predetermined value.

17. The diagnostic system of claim 16 wherein the fifth fault is associated with hardware of a perception system of the vehicle.

18. The diagnostic system of claim 1 wherein the fault module is configured to determine the severity value further based on a first value that is indicative of a difference between labels attributed to features of the image captured by the camera and labels attributed to one of a plurality of normal images.

19. The diagnostic system of claim 18 wherein the fault module is configured to determine the severity value further based on:
a second value that is indicative of a difference between the image captured by the camera and the one of the normal images; and
a third value that is indicative of a difference between a first location at which the camera captured the image and a second location where the one of the normal images was captured.

20. A diagnostic method comprising:
extracting features present in an image captured by a camera of a vehicle;
extracting features present in the image captured by the camera of the vehicle;
matching the image captured by the camera with first images stored in a database;
identifying one of the first images based on the matching;
based on a comparison of the identified one of the first images with the image captured by the camera, determining a score value that corresponds to closeness between the identified one of the first images and the image captured by the camera;
determining a severity value based on the score value;
selectively diagnosing a fault when the severity value is greater than a first predetermined value; and
outputting a fault indicator based on the diagnosis.
